(19) United States
(12) Patent Application Publication
(10) Pub. No.: US 2026/0149748 A1
(43) Pub. Date: May 28, 2026

(54) ACCESSING NETWORKED DEVICE PROPERTIES IN MIXED REALITY APPLICATIONS

(71) Applicant: simpleAR, Inc., Irvine, CA (US)

(72) Inventors: Julian Volyn, Long Valley, NJ (US); Michael Davis, Yorba Linda, CA (US); TJ Southard, Newport, NC (US); Phillip Do, Chandler, AZ (US); Marlo Brooke, Newport Coast, CA (US); Josh Zavaleta, Aliso Viejo, CA (US); Scott Toppel, Virginia Beach, VA (US)

(21) Appl. No.: 18/957,449

(22) Filed: Nov. 22, 2024

(51) Int. Cl. H04L 67/131; H04L 41/12

(52) U.S. Cl. CPC H04L 67/131; H04L 41/12

(57) ABSTRACT

The facility provides an environment for creating a mixed reality (MR) application. Input specifying a property of a networked device is to be accessible in the mixed reality application is received. Properties of one or more networked devices are identified. A property selection interface is provided in the environment for creating the mixed reality application. The facility receives, via the property selection interface, selection of a networked device of the one or more networked devices and a property of the networked device. The facility configures the MR application to provide, to a device executing the MR application, access to the selected property of the selected networked device. The MR device can execute the MR application to access the selected property of the selected networked device.

### CROSS-REFERENCE TO RELATED APPLICATIONS

This Application is related to U.S. application Ser. No. 18/783,227, filed on Jul. 24, 2024, and entitled “XR DEVICE-BASED TOOL FOR CROSS-PLATFORM CONTENT CREATION AND DISPLAY”, which is hereby incorporated by reference in its entirety.

This Application is related to U.S. application Ser. No. 18/583,357, filed Feb. 21, 2024, and entitled “DEVELOPING MIXED REALITY APPLICATIONS IN CONNECTION WITH A VIRTUAL DEVELOPMENT ENVIRONMENT,” which is hereby incorporated by reference in its entirety.

In cases where a document incorporated by reference herein and the present application conflict, the present application controls.

### BACKGROUND

A mixed reality application displays virtual objects to a viewer such that the virtual objects appear to the viewer to exist in a physical environment around the viewer. For example, a model of a turbojet may be displayed to a viewer using a mixed reality application.

Networked devices are devices capable of communicating over the internet or other networks. For example, a networked thermostat may transmit values of measured temperatures and receive instructions to control temperature over the internet.

### BRIEF DESCRIPTION OF THE DRAWINGS

FIG. 1 is a network diagram showing an environment in which the facility operates.

FIG. 2 is a block diagram showing some of the components typically incorporated in at least some of the computer systems and other devices on which the facility operates.

FIG. 3 is a logical flow diagram showing a process used by the facility in some embodiments to provide an environment for creating MR applications that access networked devices.

FIG. 4 is a display diagram showing an interface used by the facility in some embodiments to manage networked devices for use in mixed reality applications.

FIG. 5 is a display diagram showing an interface used by the facility in some embodiments to manage properties of a networked device for use in mixed reality applications.

FIG. 6 is a display diagram showing an interface used by the facility in some embodiments to include a callout in a mixed reality application.

FIG. 7 is a display diagram showing an interface used by the facility in some embodiments to select properties of a networked device to be used in a mixed reality application.

FIG. 8 is a display diagram showing an interface used by the facility in some embodiments to configure access of a property of a networked device using a mixed reality application.

FIG. 9 is a logical flow diagram showing a process used by the facility in some embodiments to access a property of a networked device in a mixed reality application.

FIG. 10 is a display diagram showing an interface used by the facility in some embodiments to provide access to a property of a networked device while executing a mixed reality application.

### DETAILED DESCRIPTION

Networked devices often include sensors to measure various conditions. Complex systems can include many networked devices each having numerous sensors. For example, aircraft include flight instruments to measure pressures, speeds, temperatures, levels, and other metrics associated with performance of the aircraft. Based on the measurements provided by the flight instruments, the pilot determines actions to perform. But it is typically not obvious which sensor measurements are relevant at a given time, nor which actions are to be taken based on the measurements. Aircraft pilots require years of specialized training to understand measurements associated with an aircraft and determine a proper course of action based on these measurements.

Operating networked devices can also be burdensome. A physical control panel used to operate networked devices may include hundreds of knobs, switches, buttons, etc. The control panel may even be in a different physical location to which a user must travel. Digital control panels or software interfaces may include controls in various nested menus or other interfaces a user must navigate. Unintuitive and error-prone interfaces is another disadvantage of conventional device controls.

In response to recognizing the importance of interacting with networked devices in MR applications and the disadvantages of conventional techniques for creating MR applications, the inventors have conceived and reduced to practice a software and/or hardware facility for accessing networked device properties in a mixed reality application (“the facility”).

In some embodiments, the facility provides an environment for creating a mixed reality application. The facility receives, via the environment for creating the mixed reality application, input specifying that a property of a networked device is to be accessible in the mixed reality application. The facility identifies properties of one or more networked devices. In response to receiving the input specifying that the networked device property is to be accessed, the facility presents, based on the identified properties of the one or more networked devices, a property selection interface in the environment for creating the mixed reality application. The facility receives, via the property selection interface, selection of a networked device of the one or more networked devices and a property of the networked device. The facility configures the MR application to provide, to a device executing the MR application, access to the selected property of the selected networked device.

Once the MR application has been configured to access the selected property of the selected networked device, an MR device can execute the MR application to access the selected property of the selected networked device for use in an MR experience. In some embodiments, the MR device provides a virtual object based on the selected networked device property. In some embodiments, the MR device writes to the selected networked device property, such as in response to receiving interaction with a virtual object associated with the selected networked device property in the MR experience.

In some embodiments where the MR experience includes one or more sequences of MR steps, the MR device selects an MR step or MR sequence to present based on a value of the selected networked device property. In one non-limiting example, the MR device selects an MR sequence to shut down a turbojet in response to determining that an RPM value of the turbojet is outside a safe operating range.

By performing in some or all of the ways described above, the facility accesses networked device properties in mixed reality applications. Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. By facilitating access of networked device properties in MR applications, the facility improves the performance of computers used to create MR applications. For example, fewer computing resources are needed to provide interfaces for creating custom solutions for accessing the device properties. Additionally, the performance of MR devices accessing the device properties is improved because the MR device does not necessarily have to manage direct connections with each networked device. Rather, the MR device can access information associated with each networked device through a device management server.

Further, for at least some of the domains and scenarios discussed herein, the processes described herein as being performed automatically by a computing system cannot practically be performed in the human mind, for reasons that include that the starting data, intermediate state(s), and ending data are too voluminous and/or poorly organized for human access and processing, and/or are a form not perceivable and/or expressible by the human mind; the involved data manipulation operations and/or subprocesses are too complex, and/or too different from typical human mental operations; required response times are too short to be satisfied by human performance; etc. For example, a human mind cannot cause a property selection interface to be presented in an environment for creating MR applications. Nor can a human mind configure an MR application to provide access to a property of a networked device to a device executing the MR application.

By operating in at least some of the ways described above, the facility enables intuitive interactions with networked devices. An MR application created using the facility may display various measurements associated with a networked turbojet such as temperature, rotations per minute, pressure, fuel level, etc. Display of the measurements may also be controlled based on values of the measurements or other variables. For example, certain pressure values detected in a turbojet indicate that the turbojet is experiencing a dangerous condition such as compressor stall. In response to detecting these pressure values, the MR application can display the pressure values or an indication that the turbojet is experiencing compressor stall. Because information displayed in an MR application is fully customizable, the visual clutter and extraneous information of conventional control panels is reduced.

MR applications created using the facility can also guide users through a sequence of one or more MR steps based on various measurements received from networked devices. For example, an MR application can indicate a sequence of one or more physical controls in an airplane cockpit to be actuated to resolve a detected compressor stall in the turbojet.

Furthermore, the facility can be used to control networked devices using virtual object-based controls, such as by displaying a virtual slider to control throttle of the turbojet. Thus, MR applications can supplement or fully replace conventional control or monitoring instruments for various networked devices.

Augmented reality (i.e., “AR”), mixed reality (i.e., “MR”), and virtual reality (i.e., “VR”), collectively, “XR” can be used to provide users with interactive experiences. Augmented reality generally refers to experiences wherein virtual artifacts are overlaid onto real-world scenes. Mixed reality generally refers to experiences wherein virtual artifacts are displayed and can interact with real-world objects. Virtual reality generally refers to experiences wherein the scene is entirely virtual. While embodiments described herein are discussed in terms of mixed reality for ease of discussion, various embodiments are directed to AR, MR, or VR experiences.

An MR application may include one or more MR procedures. An MR procedure includes one or more sequences of MR steps. In some embodiments, an MR procedure corresponds to a task to be performed by a viewer of an MR experience based on the MR application. An MR step may correspond to an action to be taken in accomplishing the task. For example, in an MR procedure designed to instruct the viewer how to turn on a turbojet, a first MR step may include verifying turbojet settings, and a second MR step may include activating a fuel system of the turbojet. In some embodiments, virtual objects corresponding to the mixed reality steps are sequentially displayed to guide the viewer through the MR procedure. In some embodiments, the facility displays animations in one or more of the MR steps. Continuing the above example, in the first MR step, the facility displays an interface including settings or sensor values associated with the turbojet. In various embodiments, the interface includes real-time or near-real-time networked device properties associated with the turbojet. For example, the interface may display one or more of a rotations per minute (i.e., “RPM”), temperature, flow rate, pressure, etc. associated with the turbojet to enable. In some embodiments, a selected set of networked device properties are displayed for an MR step. For example, when an action is to be taken based on a pressure and temperature of the turbojet, the MR step displays the pressure and temperature of the turbojet. In some embodiments, the set of networked device properties to be displayed is based on one or more networked device property values. For example, when the temperature of the turbojet is within a selected range of values, the facility may not display the temperature. But when the temperature is outside a selected range of values, the facility may display the temperature.

As discussed herein, the MR application may include sequences of one or more MR steps. For example, an MR application for piloting an aircraft may include a first MR sequence for takeoff and a second MR sequence for landing. The MR steps included in each sequence may be in a selected order, or may be dynamically determined based on one or more networked device property values.

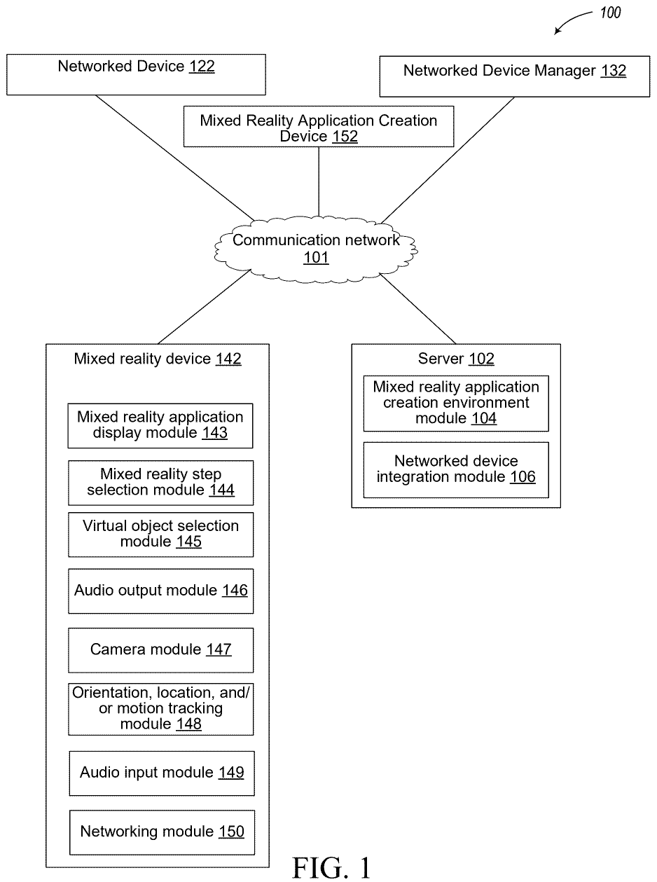

FIG. 1 is a network diagram showing an environment 100 in which the facility operates. Environment 100 includes server 102, networked device 122, networked device manager 132, and mixed reality device 142 connected by communication network 101. Collectively, the elements depicted in environment 100 enable creation of a mixed reality application using a mixed reality application creation environment (e.g., the “creation environment”), such that the mixed reality application accesses a networked device property.

Communication network 101 is configured to enable communication between networked device 122, mixed reality application device 152, networked device manager 132, server 102, or mixed reality device 142, or other computing devices. includes one or more wired connections, wireless connections, or any combination thereof.

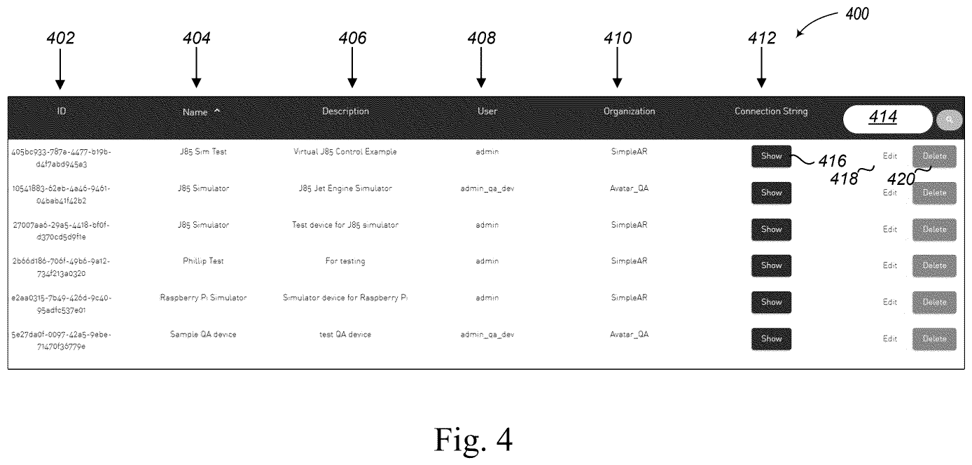

Server 102 is configured to provide a mixed reality application creation environment that enables networked device properties to be accessed in mixed reality applications. Nonlimiting examples of interfaces provided using the creation environment are depicted in FIGS. 4-8.

Server 102 includes mixed reality application creation environment module 104 (i.e. “creation environment module 104”) and networked device integration module 106.

Creation environment module 104 is configured to provide an MR application creation environment (i.e., the “creation environment”). The creation environment is configured to enable a user to create an MR application using various interfaces.

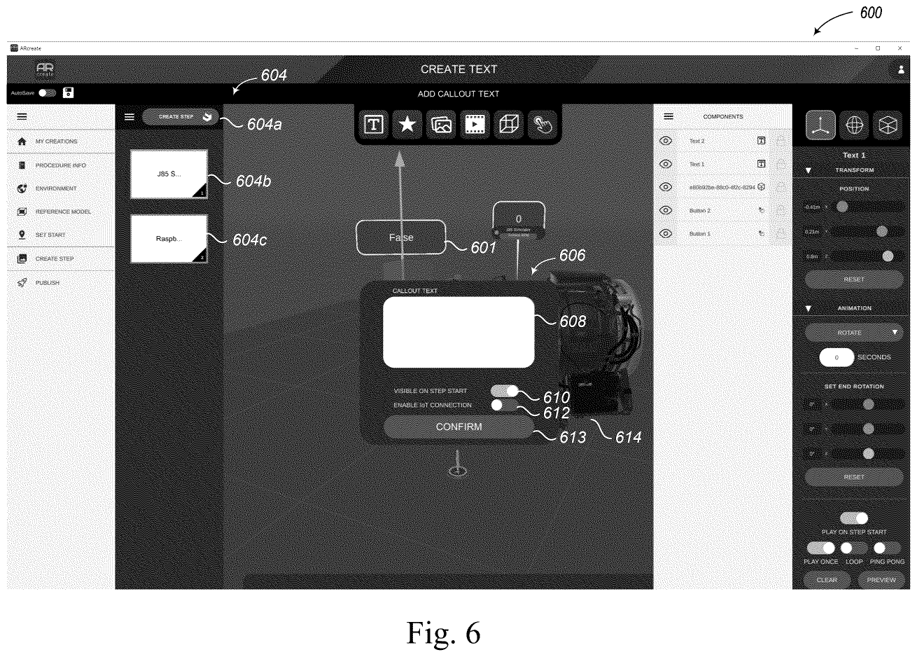

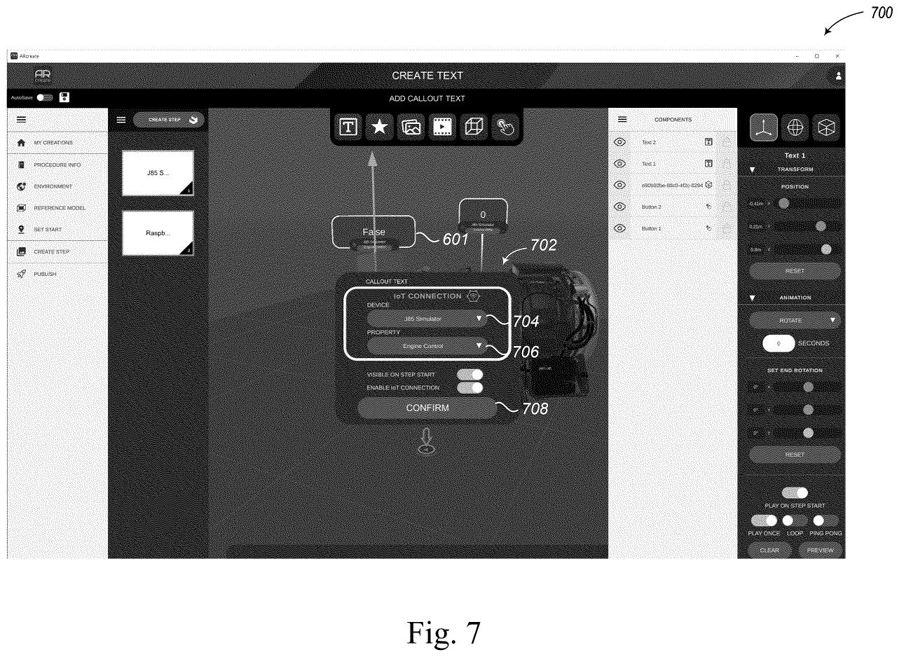

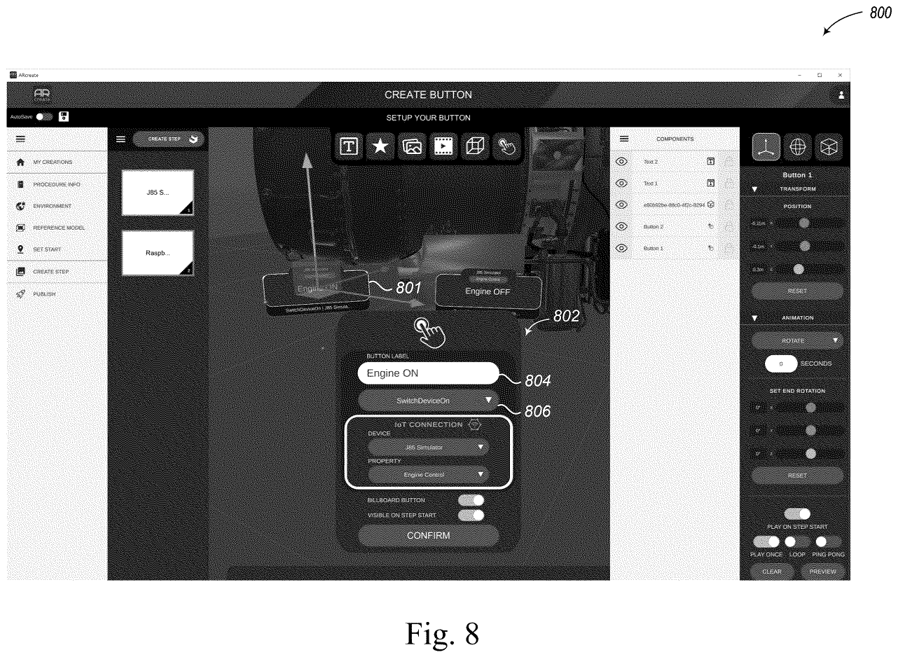

In some embodiments, creation environment module 104 is configured to provide an interface to include a callout in a mixed reality application as shown in FIG. 6. In some embodiments, creation environment module 104 is configured to provide an interface to select a property of a networked device, as shown in FIG. 7. In some embodiments, creation environment module 104 is configured to provide an interface to access a property of a networked device, as shown in FIG. 8. Aspects of the creation environment are described in further detail in U.S. application Ser. No. 18/783,227, filed on Jul. 24, 2024, and entitled “XR DEVICE-BASED TOOL FOR CROSS-PLATFORM CONTENT CREATION AND DISPLAY”, which is hereby incorporated by reference in its entirety. Aspects of the creation environment are also described in further detail in U.S. application Ser. No. 18/583,357, filed Feb. 21, 2024, and entitled “DEVELOPING MIXED REALITY APPLICATIONS IN CONNECTION WITH A VIRTUAL DEVELOPMENT ENVIRONMENT,” which is hereby incorporated by reference in its entirety.

In some embodiments, creation environment module 104 is configured to provide the creation environment via a web browser or online service. In some embodiments, creation environment module 104 is configured to provide the creation environment by providing data to an application executed using mixed reality application creation device 152.

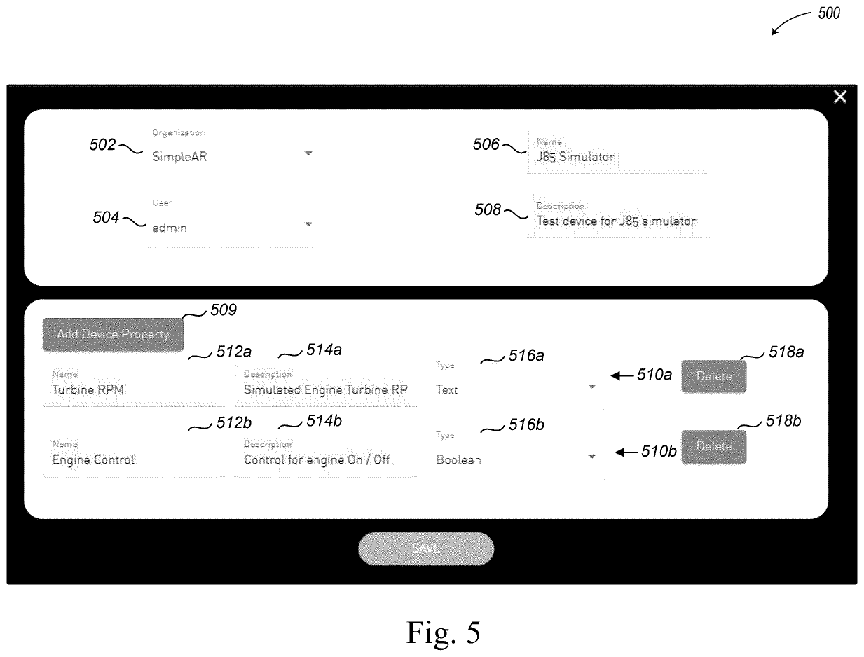

Networked device integration module (i.e., “networked device module”) 106 is configured to manage accessing properties of networked devices in creating or executing MR applications. In some embodiments, networked device module 106 is configured to display an interface for managing networked devices, as shown in FIG. 4. In some embodiments, networked device module 106 is configured to provide an interface to manage properties of a networked device, as shown in FIG. 5. Based on input received via the interfaces, networked device integration module 106 enables configuration of MR applications to access the properties of the networked device when executed.

In various embodiments, networked device module 106 is configured to access networked device properties from networked device manager 132 or networked device 122 and provide mixed reality device 142 access to the networked device property. In some embodiments, networked device module 106 configures mixed reality device 142 to access the networked device property from networked device 122 or networked device manager 122, without server 102 necessarily accessing the networked device property.

Mixed reality application creation device 152 (i.e. the “creation device”) is configured to enable creation of a mixed reality application. In some embodiments, creation device 152 is configured to enable creation of the MR application by accessing a software-as-a-service (i.e., “SaaS”) provided by server 102, such as via an internet browser. In some embodiments, creation device 152 is configured to execute an application to provide the creation environment, and receives permission, networked device properties, or both, to provide the creation environment via server 102. In one non-limiting example, the creation environment is a desktop application executed using creation device 152. Creation device 152 obtains permission, access to device properties, etc. via server 102. In some embodiments, server 102 provides the creation environment to creation device 152, such as via an internet browser.

In various embodiments, creation device 152 is an MR device such as Hololens®, Oculus®, Magic Leap®, smartphone, tablet, etc. In some embodiments, creation device 152 is a user device such as a desktop computer, laptop computer, etc. In some embodiments, creation device 152 is mixed reality device 122.

Networked device 122 is a device that provides access to one or more of its device properties via communication network 101. In some embodiments, networked device 122 provides read access to a device property such as a sensor measurement, device status, etc. In some embodiments, networked device 122 provides write access to a device property such as a device setting or I/O of the networked device. In one non-limiting example, networked device 122 provides read access to a sensor measurement, and write/read access to a property that controls a device associated with networked device 122 such as an actuator.

Networked device 122 is configured to communicate with one or more of server 102, networked device manager 132, or mixed reality device 142 via communication network 101. In some embodiments, networked device 122 is an Internet of Things (i.e. “IoT”) device. In various embodiments, networked device 122 is configured to communicate with other computing devices using Bluetooth, Modbus, Zigbee, MQ Telemetry Transport (i.e., “MQTT”), or any other communication protocol.

As used herein, the phrase “networked device” may refer to a computing device that enables device properties to be accessed, a component or system associated with the computing device, or any combination thereof. In various non-limiting examples, the term “networked device” may refer to a computing device configured to provide access to a property associated with a sensor of a turbojet fuel system, the sensor, the fuel system, the turbojet, etc. or any combination thereof.

While only one networked device 122 is shown for ease of discussion, in various embodiments environment 100 includes any number of networked devices.

Networked device manager 132 is configured to manage communications between networked device 122 and other computing devices such as server 102 or mixed reality device 142. In some embodiments, networked device manager is an MQ Telemetry Transport (i.e., “MQTT”) broker that communicates with networked device 122 using MQTT. MQTT is a publish-subscribe protocol used to access properties of networked devices. A networked device such as networked device 122 can “publish” data, which includes sending the data to networked device manager 132. Computing devices such as server 102 or may “subscribe” via networked device manager 132 to receive the data associated with networked device 122. In some embodiments, server 102 facilitates MR device 142 accessing networked device properties by subscribing to each networked device having a property accessed in an MR application, and forwarding published values for the networked device properties to MR device 142.

In some embodiments, networked device manager 132 and server 102 are implemented on a same computing device or virtual machine. In some embodiments, networked device manager 132 and server 102 are implemented on different computing devices or virtual machines.

Mixed reality (i.e. “MR”) device 142 is configured to provide a mixed reality experience to a viewer. In the example shown in FIG. 1, MR device 142 includes mixed reality application display module 143; mixed reality step selection module 144; virtual object selection module 145; audio output module 146 configured to output audio, camera module 147 configured to obtain images; orientation, location and/or motion tracking module 148 configured to obtain orientation, location, and/or motion tracking data; audio input module 149 configured to obtain audio; and networking module 150 configured to enable communication with other devices via communication network 101 or other wired or wireless connections.

Mixed reality application display module 143 is configured to receive data from a camera, lidar scanner, etc., including data based on a physical reference object. Then, mixed reality device 142 provides a mixed reality experience to a viewer based on the data.

Mixed reality step selection module 144 is configured to select a step or sequence of steps to display in the MR experience based on a property of networked device 122. Selecting a step or sequence of steps based on a property of networked device 122 is discussed in detail at least with respect to FIG. 6.

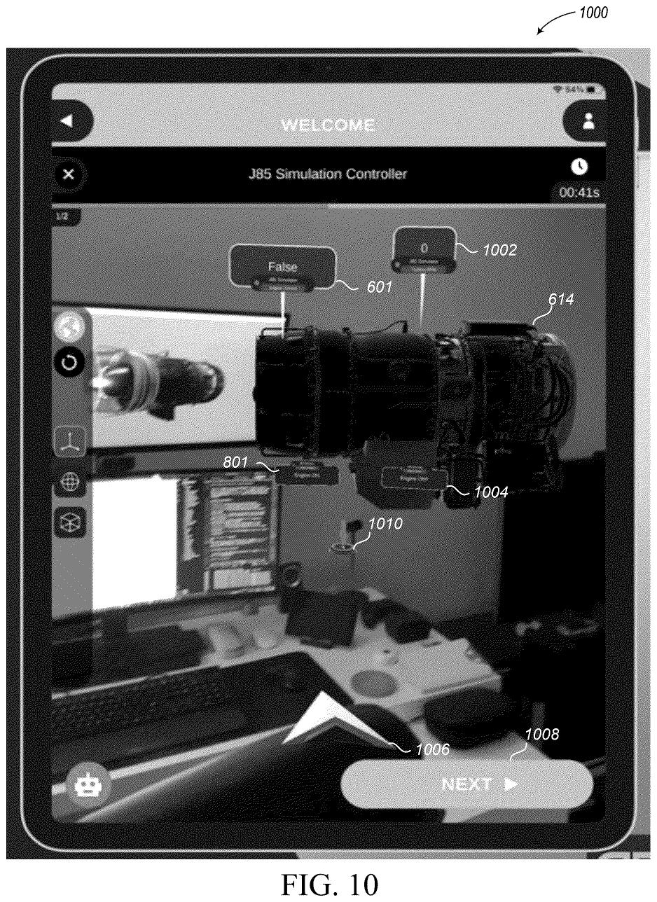

Virtual object selection module 145 is configured to select or modify a virtual object based on a property of networked device 122. Selecting or modifying a virtual object based on the property is discussed at least with respect to FIG. 10.

In various embodiments, the property of networked device 122 is accessed via networked device 122, server 102, or networked device manager 132.

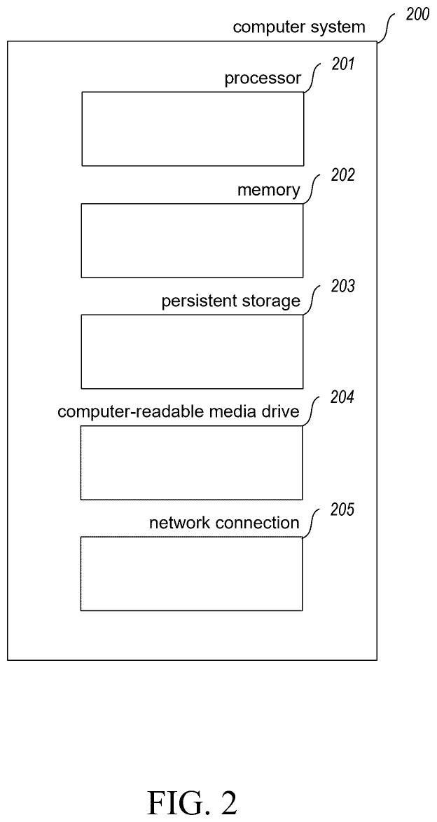

FIG. 2 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202—such as RAM, SDRAM, ROM, PROM, etc.—for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. None of the components shown in FIG. 2 and discussed above constitutes a data signal per se. While computer systems configured as described above are typically used to support the operation of the facility, those skilled in the art will appreciate that the facility may be implemented using devices of various types and configurations, and having various components.

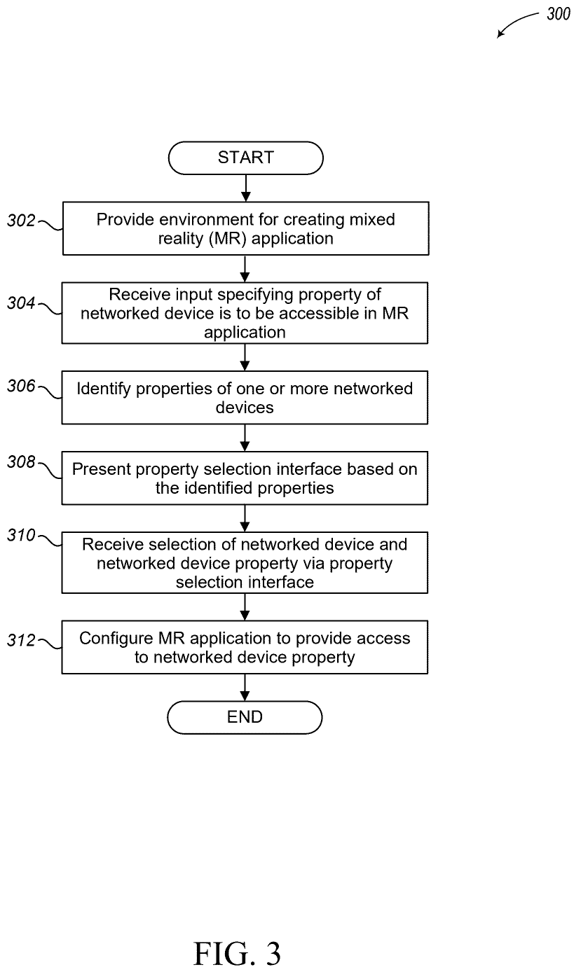

FIG. 3 is a logical flow diagram showing a process 300 used by the facility in some embodiments to provide an environment for creating MR applications that access networked devices. In various embodiments, process 300 is implemented using creation device 152, server 102, or any combination thereof.

Process 300 begins, after a start block, at block 302, where the facility provides an environment for creating a mixed reality (MR) application (i.e., “the creation environment”). In various embodiments, the facility provides the creation environment using creation environment module 104 and networked device integration module 106 of FIG. 1. In some embodiments, the facility provides the creation environment using an MR application creation device such as MR application creation device 152 of FIG. 1 via an application, an internet browser, etc. In various embodiments, process 300 is performed using server 102 of FIG. 1, mixed reality application creation device 152 of FIG. 1, or any combination thereof.

In various embodiments, the facility provides the creation environment via MR device 124 or any other computing device. Non-limiting examples of interfaces of the environment for creating the MR application are shown in FIGS. 4-8. After block 302, process 300 continues to block 304.

At block 304, the facility receives input specifying that a property of a networked device is to be accessible in the MR application. IoT connection input 612 of FIG. 6 shows one non-limiting example of an interface used by the facility to receive input specifying that the property of the networked device is to be accessible in the MR application.

In some embodiments, receiving the input includes receiving selection of a toggle or other interfacing object. In some embodiments, receiving the input includes receiving a voice command. In some embodiments, receiving the input includes receiving selection of a virtual object for which one or more associated device properties are available. In one non-limiting example, virtual turbojet 614 of FIG. 6 is associated with one or more device properties. Accordingly, selection of virtual turbojet 614 for inclusion in the MR application specifies that the one or more properties corresponding to virtual turbojet 614 are to be accessible in the MR application. After block 304, process 300 proceeds to block 306.

At block 306, the facility identifies properties of one or more networked devices. In some embodiments, the facility identifies the properties of the one or more networked devices by obtaining the properties via the one or more networked devices. In one non-limiting example, the facility requests a networked devices to identify one or more properties associated with the networked devices.

In some embodiments, the facility identifies the properties of the one or more networked devices by obtaining the properties via a networked device manager such as networked device manager 132 of FIG. 1. In one non-limiting example, the networked device manager maintains a data structure that identifies accessible networked device properties. The accessible networked device properties may be determined based on an account of a user interacting with the creation environment.

In some embodiments, the properties are limited to those that a user has permission to access. In some embodiments, the user account is permitted to access networked device properties of networked devices associated with the user account. In some embodiments, the user can be authorized to access some, but not all, of the networked device properties. In some embodiments, permissions can include differential access or different access levels for users. In one non-limiting example, networked device manager 132 manages networked devices associated with a plurality of user accounts. Accordingly, identifying properties for use may include identifying properties associated with the user account interacting with the creation environment. In some embodiments, the user account is associated with a user that created the MR application or mixed reality application creation device 152.

In some embodiments, the facility identifies the properties based on user input received via the creation environment or another user interface. In one non-limiting example, the facility provides an interface to manage properties of a networked device, such as interface 500 of FIG. 5.

In various embodiments, any number of properties corresponding to any number of networked devices are identified. After the facility identifies properties of one or more networked devices at block 306, process 300 continues to block 308.

At block 308, the facility presents a property selection interface based on the identified properties. In some embodiments, the property selection interface includes a device selection component and a property selection component, as shown in FIG. 7. The device selection component is used to selected device, and the property selection component is used to select a property of the device. After block 308, process 300 continues to block 310.

At block 310, the facility receives selection of a networked device and a networked device property via the property selection interface. In some embodiments, in response to receiving selection of the networked device, the facility presents one or more properties of the networked device. The facility then receives selection of the property of the networked device.

In some embodiments, the property selection interface includes a virtual object that corresponds to the networked device. In one non-limiting example, when the networked device is a turbojet, the property selection interface includes a virtual model of the turbojet with callouts or other visual indicators corresponding to the properties of the turbojet. The visual indicators may be components of the virtual object that correspond to properties. For example, a fuel system of the turbojet may be shaded or otherwise distinguished from other components of the turbojet. Selection of the fuel system selects a property that corresponds to the fuel system such as fuel flow rate. After block 310, process 300 continues to block 312.

At block 312, the facility configures the MR application to provide access to the selected device property of the selected networked device (i.e., the “selected device property”). In some embodiments, the facility configures the MR application to provide access to the selected device property via a server such as server 102 of FIG. 1. In one non-limiting example, server 102 includes a data structure that maps connection strings to networked devices such as networked device 122. Selection of the networked device and networked device property causes the facility to provide the MR application with the connection string. When the MR application is being executed, it accesses the selected device property by providing the connection string to server 102. Server 102 uses the connection string to identify the selected device property, and communicates with the corresponding networked device to access the selected device property.

In some embodiments, the MR application is configured to provide access to the selected device property via a networked device manager such as networked device manager 132 of FIG. 1.

In some embodiments, providing access to the selected device property includes establishing a bidirectional connection between an MR device executing the MR application and the networked device. As discussed herein, the bidirectional connection may enable the MR device to read values of properties of the networked device, write properties of the networked device, or both. In some embodiments, the bidirectional connection is established using a web socket.

While process 300 is described in terms of providing access to one device property of one networked device, the disclosure is not so limited. Embodiments of process 300 can be used to provide access to any number of networked device properties in any number of MR steps of an MR application.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 4 is a display diagram showing an interface 400 used by the facility in some embodiments to manage networked devices for use in mixed reality applications.

Interface 400 includes fields IDs 402, names 404, descriptions 406, user 408, organization 410, and connection string display buttons 412. The facility is configured to show a connection string for the corresponding networked device in response to receiving selection of show button 416. The facility provides an interface for editing a networked device profile in response to receiving selection of edit button 418. Non-limiting examples of the interface for editing the networked device profile are discussed with respect to FIG. 5. The facility deletes a corresponding networked device profile in response to receiving selection of delete button 420.

In some embodiments, the networked device profiles shown in interface 400 are based on a permission of a user account accessing interface 400. In some embodiments, a user account creating an MR application only has permission to access devices added to interface 400.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

FIG. 5 is a display diagram showing an interface 500 used by the facility in some embodiments to manage properties of a networked device for use in mixed reality applications. In some embodiments, the facility provides interface 500 in response to receiving selection of edit button 418 of FIG. 4.

Interface 500 is configured to receive information regarding one or more properties of a networked device. Once information regarding a networked device property is specified using interface 500, the facility may enable selection of the networked device property in an MR application creation environment, as shown in FIGS. 7 and 8. For example, interface 500 includes turbine RPM property 510a and engine control property 510b for networked device J85 Simulator. Because these properties have been specified, engine control property 510b can be selected for access in an MR application, as shown in property selection interface 702.

Interface 500 includes organization field 502, user field 504, name field 506, and description field 508. In some embodiments, the user account accessing interface 500 is not permitted to modify one or more fields of interface 500. In one non-limiting example, the facility automatically populates one or more fields such as organization field 502, user field 504, or both, based on the user account accessing interface 500.

In some embodiments, interface 500 includes add device property button 509 and one or more device property profiles. Turbine RPM property 510a includes name field 512a, description field 514a, and type 516a. Selection of delete button 518a deletes turbine RPM property 510a. Engine control property 510b includes name field 512b, description 514b, and type 516b. Selection of delete button 518b deletes engine control property 510b.

In some embodiments, interface 500 represents a schema for establishing a virtual twin of a networked device. A virtual twin refers to a representation of a networked device accessible in an MR environment. The virtual twin may include a virtual model associated with the networked device, one or more properties of the networked device, etc.

In some embodiments, values of properties of the virtual twin correspond to values of properties of the networked device. In one non-limiting example, values of properties of the virtual twin are obtained via the networked device.

In some embodiments, values of properties of the virtual twin do not correspond to values of the networked device. For example, when the virtual twin is used to simulate behavior of the networked device, values of the properties of the virtual twin are simulated.

As shown in interface 500, the schema for the virtual twin includes two properties, turbine RPM property 510a and engine control property 510b. Turbine RPM property 510a and engine control property 510b correspond to properties of a turbojet. When the device properties are device properties of a physical turbojet, logic associated with the device property is determined by way of actual operation of the turbojet. For example, when engine control property 510b has a value of false (e.g., the corresponding turbojet is off), the turbine property 510a may have a value of 0. When engine control property 510 b has a value of true (e.g., the corresponding turbojet is on), turbine property 510 may have a value greater than 0. But as described herein, a virtual twin of a networked device may be used to simulate behavior of the networked device.

To enable simulation of the networked device, in some embodiments interface 500 enables configuration of rules, equations, relationships, machine learning models, etc. to simulate the corresponding networked device. In some embodiments, interface 500 is configured to enable the user to specify a relationship between a first value of a first property and a second value of a second property. For example, a user may specify an equation that specifies a relationship between a throttle property (not shown) and turbine RPM property 510a. When a user subsequently interacts with the throttle property in an MR experience that accesses the device properties specified using interface 500, the engine turbine RPM property can be simulated based on the specified equation and the throttle property.

FIG. 6 is a display diagram showing an interface 600 used by the facility in some embodiments to include a callout in a mixed reality application.

Interface 600 includes virtual object 601, callout interface 606, and MR step interface 604. As discussed herein, an MR application may include one or more MR steps. In various embodiments, an MR step is associated with an action to be taken by a viewer of an MR experience provided based on execution of the MR application, a value of a networked device property, etc. As shown in interface 600, MR step interface 604 includes a create step button 604a configured to add a new MR step, a first MR step 604b, and a second MR step 604c.

Callout interface 606 is configured to enable a user to customize a callout to be displayed in an MR experience. A callout is a virtual object displayed in an MR experience that may include text, images, or other visual features. In the example shown in FIG. 6, callout interface 606 includes callout text field 608, which is configured to receive input text to display in a callout of an MR experience. Visibility input 610 is configured to enable selection of a visibility status of the callout. IoT connection input 612 is configured to enable the callout to access a networked device property. In some embodiments, the facility is configured to display an interface such as interface 700 of FIG. 7 in response to receiving selection of IoT connection input 612. Confirm button 613 is configured to save customization of the callout.

While IoT connection input 612 is shown as enabling the callout to access the networked device property, such as to display a value of the networked device property using the callout, the disclosure is not so limited. In various embodiments, an interface component similar to IoT connection input 612 is usable to configure any aspect of the MR application to access a networked device property. In some embodiments, an interface component similar to IoT connection input 612 is provided in MR step interface 604 (not shown) and is usable to control a progression of MR steps, such as a progression from first MR step 604b to second MR step 604c. Non-limiting examples of controlling a progression of MR steps based on a networked device property are discussed below.

As shown in FIG. 6, first MR step 604b and second MR step 604c progress sequentially. The facility presents first MR step 604b, and then presents second MR step 604c. In some embodiments, the facility is configured to present a next MR step based on a networked device property. In one non-limiting example, first MR step 604b and second MR step 604c are part of a sequence for turning on a turbojet, such as a turbojet that corresponds to virtual turbojet 614. First MR step 604b corresponds to turning on an electrical system associated with the turbojet. In this example, the property may be an on/off status of the electrical system. When the electrical system is on, the sequence of turning on the turbojet proceeds to second MR step 604c, which corresponds to a next step in the sequence for turning on the jet engine.

While the example described above relates to controlling progression of a linear sequence of MR steps based on networked device properties, the disclosure is not so limited. In some embodiments, the facility enables configuration of a progression of the MR steps that includes a branch, wherein a next MR step is selected from two or more MR steps based on a networked device property. For example, when an airspeed of an aircraft is above a first threshold, the facility can be configured to present one or more MR steps for reducing the airspeed, such as by reducing a throttle of a turbojet. When an airspeed of the aircraft is below the second threshold, the facility can be configured to present one or more MR steps for increasing airspeed, such as by increasing the throttle of the turbojet.

In some embodiments, an MR sequence is configured to access one or more networked device properties that correspond to a physical system. For example, actions taken by a viewer of an MR experience including first MR step 604b may access properties associated with a physical turbojet that corresponds to virtual turbojet 614.

In some embodiments, the facility configures the MR sequence to access one or more networked device properties that correspond to a simulated system, such as for training purposes. For example, actions taken by a viewer of an MR experience including first MR step 604b may access properties associated with a simulated turbojet that corresponds to virtual turbojet 614.

In some embodiments, the facility enables configuration of the MR sequence to write a value to a property of a virtual twin of a networked device. The virtual twin then simulates a result of writing the value to the virtual twin based on logic associated with the virtual twin. For example, virtual turbojet 614 may be configured to increase a device property associated with a pressure or RPM of the virtual turbojet in response to an increased throttle value being written to the virtual twin.

Based on the simulated result of the virtual twin, the facility determines whether to write the value to the property to the networked device. In one non-limiting example, when an MR step corresponds to increasing throttle of a turbojet and an action taken in the MR experience causes a throttle of a virtual twin of the turbojet to decrease, the facility does not write the value to the throttle of the turbojet. In this way, the facility enables simulation of writing a value to a networked device property using a virtual twin, and writing to the property of the networked device based on the simulation.

While the examples above discuss selecting a next MR step based on one networked device property for ease of discussion, the disclosure is not so limited. In various embodiments, a next MR sequence of one or more MR steps is selected based on any number of networked device properties corresponding to any number of networked devices.

FIG. 7 is a display diagram showing an interface 700 used by the facility in some embodiments to select properties of a networked device to be used in a mixed reality application. In some embodiments, the facility displays interface 700 in response to receiving selection of IoT connection input 612 of FIG. 6.

Interface 700 includes property selection interface 702, which includes networked device field 704 and networked device property field 706. In some embodiments, networked device property field 706 shows one or more properties of a networked device indicated by networked device field 704. As shown in FIG. 7, property selection interface 702 is used to configure virtual object 601. Accordingly, when the MR application is executed, virtual object 601 is displayed according to configuration received via property selection interface 702.

In some embodiments, networked device field 704 enables selection of a networked device from one or more networked devices. In one non-limiting example, networked device field 704 includes a drop-down menu for selecting a networked device.

In some embodiments, the facility determines available networked devices for selection via networked device field 704 based on information obtained via a networked device management interface, such as interface 400 shown in FIG. 4.

In some embodiments, the facility determines available networked device properties for selection via networked device property field based on information obtained via a networked device property management interface, such as interface 500 of FIG. 5.

In response to receiving selection of confirm button 708, the facility configures the MR application to access the selected networked device property when the corresponding MR step is executed, and to cease display of property selection interface 702.

FIG. 8 is a display diagram showing an interface 800 used by the facility in some embodiments to access a property of a networked device using a mixed reality application.

Interface 800 includes property selection interface 802. Property selection interface 802 enables configuration of virtual object 801 to write a value to the selected property. Property selection interface 802 includes button label 804 and function field 806. As shown in FIG. 8, virtual object 801 is a button, and function field 806 receives selection of a value to write to the networked device property when the button is selected in an MR experience based on the MR application. Accordingly, when a user interacts with virtual object 801 in an MR experience, the MR device displaying the MR experience will write the value to the networked device property. In the example shown in FIG. 8, the MR device will write a value to the networked device that will cause an engine to turn on.

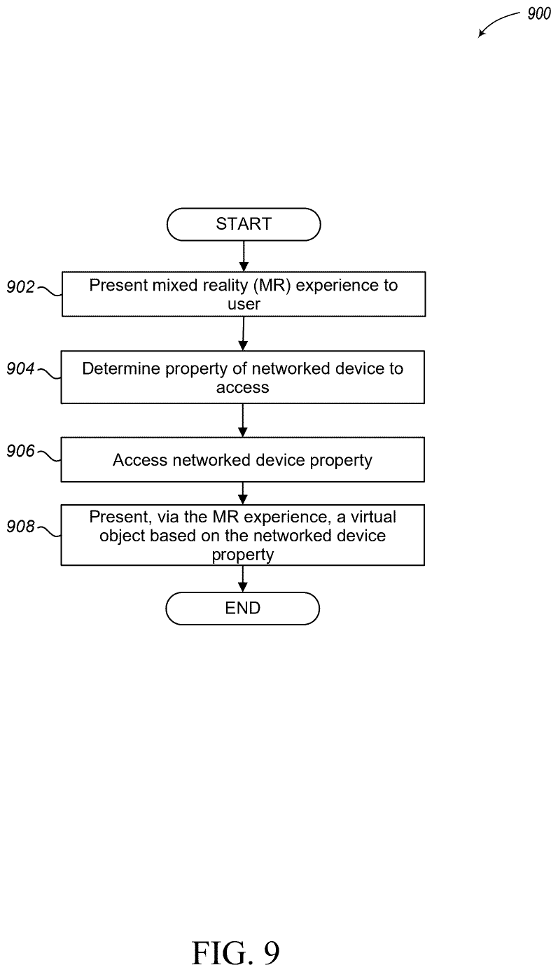

FIG. 9 is a logical flow diagram showing a process 900 used by the facility in some embodiments to access a property of a networked device in a mixed reality application. In various embodiments, process 900 is implemented using mixed reality device 142 of FIG. 1.

Process 900 begins, after a start block, at block 902, where the facility presents a mixed reality experience to a user. After block 902, process 900 proceeds to block 904.

At block 904, the facility determines a networked device property to access. In some embodiments, the facility automatically determines the property of the networked device to access. In one non-limiting example, a control flow of the MR application is based on a value of a networked device property, as discussed with respect to FIG. 6. The facility automatically accesses the networked device property to determine an MR step to display. In some embodiments, the property of the networked device to access is based on user input received via the MR experience. In one non-limiting example, the facility determines that the networked device property to access is an RPM associated with a turbojet in response to receiving selection of a virtual object that corresponds to the turbojet. After block 904, process 900 proceeds to block 906.

At block 906, the facility accesses the networked device property. In various embodiments, accessing the networked device property includes reading the networked device property, writing the networked device property, or both. As discussed herein, in some embodiments the facility accesses the networked device property via a networked device manager such as networked device manager 132 of FIG. 1. After block 906, process 900 continues to block 908.

At block 908, the facility presents, via the MR experience, a virtual object based on the networked device property. In some embodiments, the virtual object displays a value of the networked device property, such as virtual object 601 of FIG. 6. In some embodiments, the virtual object is configured to enable a value to be written to the networked device property. In one non-limiting example, the virtual object is a throttle usable to write to a throttle property of a networked turbojet.

In various embodiments, a visual aspect of the virtual object such as a color, animation, etc. is modified based on a value of the accessed networked device property. In one non-limiting example, the color of a virtual turbojet is determined based on a temperature property of the corresponding networked turbojet.

In various embodiments, the facility displays the virtual object without moving to a different MR step of the MR experience. In some embodiments, the facility determines a visibility of a virtual object in the MR experience based on a value of the networked device property. In one non-limiting example, the facility determines to make a warning callout visible when the value is outside a selected threshold. As discussed herein, in some embodiments displaying the virtual object includes displaying a next MR step in the MR experience. After block 908, process 900 ends at an end block.

FIG. 10 is a display diagram showing an interface 1000 used by the facility in some embodiments to provide access to a property of a networked device while executing a mixed reality application.

In some embodiments, interface 1000 is displayed using a mixed reality device such as Hololens®, Oculus®, Magic Leap®, a smartphone, tablet, etc.

Interface 1000 includes virtual turbojet 614 and virtual objects 601, 801, 1002, and 1004 associated with virtual turbojet 614. As discussed with respect to FIG. 6 and FIG. 7, virtual object 601 is configured to provide read access to an engine control property of virtual turbojet 614 that indicates whether virtual turbojet 614 is on or off. As discussed with respect to FIG. 8, virtual object 801 is configured to write to a SwitchDeviceOn property of virtual turbojet 614 to turn on virtual turbojet 614.

MR step marker 1010 is configured to indicate a location at which a viewer of interface 1000 is to interact with a virtual object. Direction indicator 1006 points to step market 1010. In response to receiving selection of next button 1008, the facility displays a next MR step in the MR experience. In some embodiments, the facility enables next button 1008 in response to detecting that the viewer has taken one or more actions in the MR experience. In some embodiments, the facility enables next button 1008 in response to a value of a networked device property meeting a criterion. In one non-limiting example, the facility enables next button 1008 in response to the engine control property displayed using virtual object 601 indicating that turbojet 614 is on.

While in some embodiments providing access to a property of a networked device includes explicitly displaying a virtual object that corresponds to the property, the disclosure is not so limited. As discussed herein, in some embodiments the facility is configured to access the property for purposes of determining a control flow of the MR experience or implementing other logic of the MR experience. Accordingly, in some embodiments providing access to the property includes providing access to the property to a device presenting the MR experience. Providing access to the property does not necessarily include providing access to the property to a viewer of the MR experience.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed in a computing system, the method comprising:
providing an environment for creating a mixed reality application;
receiving, via the environment for creating the mixed reality application, input specifying that a property of a networked device is to be accessible in the mixed reality application;
identifying properties of one or more networked devices;
in response to receiving the input specifying that the networked device property is to be accessed, presenting, based on the identified properties of the one or more networked devices, a property selection interface in the environment for creating the mixed reality application;
receiving, via the property selection interface, selection of a networked device of the one or more networked devices and a property of the networked device; and
configuring the MR application to provide, to a device executing the MR application, access to the selected property of the selected networked device.

2. The method of claim 1, wherein identifying the properties of the one or more networked devices includes:
providing a property management dashboard for managing the properties of the one or more networked devices; and
receiving input identifying the one or more networked device properties via the property management dashboard.

3. The method of claim 1, further comprising:
receiving input specifying a branch in a control flow for the MR application that is based on the property of the networked device.

4. The method of claim 1, wherein configuring the mixed reality (MR) application to provide access to the selected property of the selected networked device includes:
configuring the MR application to obtain a value of the property of the selected networked device via a networked device manager.

5. The method of claim 1, wherein configuring the mixed reality (MR) application to provide access to the selected property of the selected networked device includes:
configuring the MR application to obtain a device connection string usable to access the selected property of the selected networked device via a networked device manager.

6. The method of claim 1, wherein configuring the mixed reality (MR) application to provide access to the selected property of the selected networked device includes:
configuring the MR application to provide access to the selected property of the selected networked device in response to receiving interaction with a virtual object associated with the selected networked device.

7. The method of claim 1, wherein receiving selection of the networked device and the property of the networked device comprises:
presenting, using the property selection interface, the one or more networked devices;
receiving selection of the networked device from the one or more networked devices;
presenting, using the property selection interface, one or more properties of the networked device; and
receiving selection of the property of the networked device from the one or more properties of the networked device.

8. The method of claim 1, wherein configuring the MR application to provide access to the selected property of the selected networked device includes:
configuring the MR application to write to the selected property of the selected networked device.

9. The method of claim 1, wherein configuring the MR application to provide access to the selected property of the selected networked device includes:
configuring the MR application to present a virtual object usable for writing a value to the selected property of the selected networked device.

10. The method of claim 1, further comprising:
configuring the MR application to present a virtual object based on a value of the selected property of the selected networked device.

11. The method of claim 1, further comprising:
configuring the MR application to select an MR sequence to display based on a value of the selected property of the selected networked device.

12. The method of claim 1, further comprising:
configuring the MR application to select an MR step to display based on a value of the selected property of the selected networked device.

13. A system comprising:
one or more processors; and
one or more memories collectively storing instructions executable to cause the one or more processors to:
execute a mixed reality (MR) application to provide an MR experience to a user;
determine a property of a networked device to access;
access the networked device property; and
provide, via the provided MR experience, a virtual object based on the networked device property.

14. The system of claim 13, wherein the one or more processors access the networked device property by being further configured to:
provide, to a networked device manager, identifying information associated with the user; and
receive, via the networked device manager, access to the networked device property.

15. The system of claim 13, wherein the one or more processors access the networked device property by being further configured to:
obtain a connection string corresponding to the networked device;
provide the connection string to a networked device manager; and
access the networked device property via the networked device manager.

16. The system of claim 13, wherein the one or more processors access the networked device property by being further configured to:
obtain, via the mixed reality experience, user input modifying the networked device property.

17. The system of claim 13, wherein the one or more processors determine the property of the networked device to access by being further configured to:
receive, via the MR experience, interaction with a virtual object associated with the property of the networked device.

18. The system of claim 13, wherein the one or more processors provide the virtual object by being further configured to:
provide the virtual object via the MR experience based on a value of the property of the networked device.

19. One or more computer readable media collectively storing instructions executable by one or more processors to perform actions, the actions comprising:
providing an environment for creating a mixed reality (MR) application;
identifying properties of one or more networked devices;
presenting, based on the identified properties of the one or more networked devices, a property selection interface in the environment for creating the MR application;
receiving, via the property selection interface, selection of a networked device of the one or more networked devices and a property of the networked device; and
configuring the MR application to provide, to a device executing the MR application, access to the selected property of the selected networked device.

20. The one or more computer-readable media of claim 19, wherein configuring the MR application to provide access to the selected property of the selected networked device includes:
obtaining a device connection token usable to access the selected property of the selected networked device; and
configuring the MR application to make the device connection token available to the device executing the MR application.
